(19) United States
(12) Patent Application Publication
(10) Pub. No.: US 2011/0003084 A1
(43) Pub. Date: Jan. 6, 2011

(54) Process of Making Ceria-Based Electrolyte Coating

(75) Inventors: Jorg Oberste Berghaus, Oudenaarde (BE); Jean-Gabriel Legoux, Repentigny (CA); Christian Moreau, Boucherville (CA); Shiqiang (Rob) Hui, Vancouver (CA)

Correspondence Address: NATIONAL RESEARCH COUNCIL OF CANADA, 1200 Montreal Road, Building M-58 Room EG-12, OTTAWA, ON, K1A 0R6, CA

(73) Assignee: NATIONAL RESEARCH COUNCIL OF CANADA, Ottawa, ON (CA)

(21) Appl. No.: 12/918,917

(22) PCT Filed: Feb. 25, 2008
(86) PCT No.: PCT/CA2009/000236

§ 371 Date: Aug. 23, 2010

Related U.S. Application Data
(60) Provisional application No. 61/064,272, filed on Feb. 25, 2008.

(51) Int. Cl. C23C 4/10; B05D 5/12

(52) U.S. Cl. 427/453; 427/115

(57) ABSTRACT

It has been surprisingly found that injecting ceria-based particles (mean size less than 200 nm) suspended in a combustible organic solvent into a plume having a maximum temperature between about 2,600° C. and 4,000° C. to impart a mean temperature to the particles from about 2,600° C. to about 3,800° C., and to accelerate the particles to a mean velocity between about 600 to 1000 m/s, produces a thin, uniform, dense, crack-free, nanocrystalline ceria-based coating, which may be applied on porous cermet or metal substrate, for example. The physical environment of a high-velocity oxy-fuel (HVOF) thermal spraying gun suitably ably deployed using standard fuels produces these conditions. The method of the present invention is particularly useful for the cost-effective fabrication of ceria-containing electrolytes for solid oxide fuel cells (SOFCs).

### CROSS-REFERENCE TO RELATED APPLICATIONS

The present application claims the benefit of U.S. provisional application Ser. No. 61/064,272 to Jorg Oberste Berghaus et al., filed Feb. 25, 2008, entitled “Process for Making Ceria-Based Electrolyte Coating”.

### FIELD OF THE INVENTION

The present invention relates in general to a process of producing ceria-based electrolyte coatings applicable in reduced temperature solid oxide fuel cells. In particular, the invention produces thermal sprayed ceria-based coatings that can be deposited onto a metal substrate in air to produce a thin, low-porosity layer without sintering.

### BACKGROUND OF THE INVENTION

Solid oxide fuel cells (SOFCs) are highly efficient devices that convert hydrogen and hydrocarbon fuels electrochemically into electricity and heat with low environmental pollution and greenhouse gas emission. Most SOFCs comprise an anode or fuel electrode, a cathode or air electrode, and an electrolyte separating the electrodes. At the air electrode, oxygen is ionized and the oxygen ions travel through the electrolyte to the fuel electrode. At the fuel electrode hydrogen or hydrocarbon is ionized and the hydrogen ions react with oxide ions, to form water and release electrons and heat. The released electrons then travel though an interconnect conductor through an external load thereby completing the electrical circuit and generating electrical power.

For widespread commercialization and application of these devices there are still significant challenges to overcome, primarily involving the high cost of material and high overall fabrication costs. Presently widespread exploration and development of economical and technically viable fabrication techniques that can be industrially implemented is underway.

Traditional doped zirconia (YSZ) based electrolyte SOFCs operate at elevated temperatures of 900-1000° C. and thus cannot be supported by, or otherwise incorporate, metallic components. Operation at these temperatures poses high demands on the thermal compatibility of the component materials and can accelerate the degradation of the cell. Ceria based electrolytes attain equivalent ionic conductivity at much lower temperatures (450-650° C.), thereby allowing the use of substantially less expensive and more robust metal interconnects and structural components. U.S. Pat. No. 5,672,437 to Yajima et al. relates to a solid electrolyte consisting essentially of cerium oxide for a fuel cell.

There are many processes and regimes applied to ceria bulk powders, nanostructured powders, slurries, nanosized powders, precursors, solutions, suspensions, and solids to try to produce such thin, low-porosity and fully crystalline electrolyte coatings. Some known processes are extremely expensive, cannot be performed in air (i.e. require an inert atmosphere or vacuum) and/or cannot be scaled to commercially applicable industrial processes. For example, traditional methods of producing such electrolyte layers include applying a liquid or slurry to a substrate, followed by a drying step and then by calcination or sintering (>1200° C.). Sintering of the layer precludes continuous production and does not allow for metal parts to be included in the processing.

Some known processes do not realize satisfactory performance of reduced temperature SOFCs. They may not provide gas barriers and they may have cracks, especially when applied to a metal substrate.

Some known processes cannot produce thin layers, below 100 μm, and preferably below 50 μm. A low electrolyte thickness is particularly important to reduce the internal losses of the cell.

Known thermal spray processes involve feedstock powders 10-100 μm in diameter. Cerium-based powder coatings made by these methods typically show microstructural defects, such as porosity and inter-lamellar gaps within the size range of the starting powder.

It is known to replace the feedstock powders with use agglomerated ceria-based nanoparticles as feedstock. These coatings are also generally too thick and too coarse to be suitable for reduced-temperature SOFC electrolyte applications.

For example, U.S. Pat. No. 6,638,575 to Chen et al. teaches that supersonic plasma spraying, using spray modes in the Mach I to Mach II range, are suitably employed to fabricate OTMs and HTMs comprising a uniform, dense, essentially microcrack-free coating of a ceramic, or metal, or combination thereof. One example is of a crack-free oxygen transport membrane coating provided by supersonic plasma spray deposition. An example teaches the deposition of Ce_{0.8}Gd_{0.2} O₂ (CGO) ionic conducting film by subsonic plasma spraying using a nanocrystalline agglomerate powder. The patent states that the method alternatively can use high velocity oxygen fuel (HVOF) thermal spraying. Particles in the range of 5 to 80 μm are used and consequently Chen et al. does not teach a thermal spray coating of CGO thinner than 100 μm. The only example of a coating with a lower thickness according to the teachings of Chen et al. contains no cerium.

A conference publication in Thermal Spray 2007: Global Coating Solutions pp. 1052-1058 to Gadow et al. relates an HVOF-technique for fabrication of SOFCs electrolyte layers from micron-sized yttria stabilized zirconia (YSZ) nanostructured feedstock powders. The HVOF technique with acetylene as fuel gas was able to produce extremely dense coatings which can fulfill the thermo mechanical requirements for SOFC electrolyte layers. The high velocity thermal spray system visibly affected the intrinsic stresses in the coatings since the shrinkage of the coating material due to solidification and the thermal contraction during cooling was considered to be compensated by the peening effect of the impacting particles. The use of acetylene fuel, in the quantities required to operate an HVOF system, can pose a significant safety risk and is consequently severely restricted in many parts of the world, including North America.

Applicant's International Patent Application PCT/CA2006/000651 teaches a method of fine particle liquid suspension feed for thermal spray system and coatings formed therefrom and teaches an example for the production of a samarium doped ceria electrolyte for an intermediate temperature SOFC. The application teaches that plasma spraying has preferred entrainment properties and particle flight properties for spraying metal, ceramic and cermet powders, but that other torches, such as an HVOF type torch can be used. HVOF torches have high velocity and low temperature (2,500-3,500° C.) plumes in comparison with plasma spray torches (6,000-15,000° C.).

A publication in Surface & Coatings Technology 2001 (2006) 1922-1929 to Killinger et al. teaches a High-Velocity Suspension Flame Spraying (HVSFS) process for spraying nanoparticles of zirconia, alumina and titania with hypersonic speed to form thin, nanostructured ceramic coatings with potential applications as SOFC components. In spite of choosing acetylene as the fuel gas, as it provides the highest flame temperature, the flame enthalpy was not sufficient to fully melt suspended zirconia particles, and the zirconia coatings are not satisfactory. Acetylene is a high temperature fuel, burning at about 3,300° C., that cannot be widely deployed commercially because of safety concerns

As is widely known, to produce layers by thermal spray techniques, the temperature of plasma or flame must be higher than the melting point of the particles, and in most cases the plume needs to be considerably hotter than the melting point. Ceria and zirconia-based powders are high melting point ceramics, but ceria-based powders have deposition issues that zirconia-based powders do not.

There is consequently a need for a process for producing a thin, nanocrystalline, low-porosity, crack-free, ceria-based electrolyte coating that is cost-effective and industrially scalable, and can be applied to a metal substrate.

### SUMMARY OF THE INVENTION

Surprisingly it has now been found that ceria-based nanoparticles, having a mean diameter smaller than 200 nm, and preferably smaller than 100, 80, 60, 50, 30 or 20 nm, can be applied using a low temperature (2,600-4,000° C.), high velocity, thermal spray apparatus when dispersed in a combustible organic solvent. This is unexpected because the previous publication to teach suspension ceramic deposition at temperatures below about 6,000° C. (Killinger), did not sufficiently melt the YSZ particles to provide a useful coating, and ceria have similar melting temperatures to YSZ.

More surprisingly such coatings have been tested and a 2-5 fold increase in power density when used as an electrolyte has been found, in comparison with ceria-based coatings produced from plasma spraying nano- or submicron-sized particle suspensions. For example, power densities of greater than 0.92 W/cm² at 700° C. and 0.5 W/cm² at 600° C. have been obtained. No other process reported appears to be able to provide an equally efficient reduced temperature SOFC electrolyte that can be applied onto a surface having metal components, and advantageously high deposition rates are provided in comparison with vapour deposition techniques, and no vacuum or isobaric chamber is required.

Accordingly a coating process is provided, the coating process includes: providing ceria-based powder having a mean particle diameter smaller than about 200 nm, uniformly dispersing the ceria-based powder in a combustible organic solvent to form a suspension feedstock having a solids weight ratio less than about 20%, and injecting the feedstock into a plume having a maximum temperature from about 2,600° C. to 4,000° C. to vaporize and consume the combustible organic solvent and sufficiently heat and accelerate a spray jet of the precipitated solids for deposition.

The cerium-based powder preferably has a mean particle diameter smaller than 100 nm, 80 nm, 60 nm or 50 nm. In the best example provided the mean diameter is 20 nm. The ceria-based powder preferably consists essentially of cerium oxide doped or admixed with an oxide of one or more of: Nb, Ta, Gd, Sm, Y, Ca, and Sr. More preferably, the ceria-based powder consists essentially of cerium oxide doped or admixed with gadolinium oxide or samarium oxide. In the best example provided, the ceria-based powder consists essentially of cerium oxide doped or admixed with about 10 to 25 wt. % of samarium oxide, and more exactly, about 20 wt. %.

Uniformly dispersing the powder may comprise any one or more of: chemically dispersing the powder by selection of the organic solvent; chemically dispersing the powder by addition of a dispersant; mechanically agitating the suspension; and sonication. In the best example provided, all of these are performed. The combustible organic solvent preferably consists of: ethylene glycol and ethanol. In the best example provided, the combustible organic solvent is a 3:1 mixture of ethylene glycol to ethanol. The solids weight ratio is preferably less than about 15%, or less than about 5% and, in the best illustrated example, a solids weight ratio of 2.5% is used. In general the solids weight ratio can be lowered, and the feed rate of the suspension feedstock can be varied to permit a same effective solids delivery rate.

The coating process preferably involves placing a substrate to be coated at a standoff distance where the spray jet would otherwise attain a mean velocity of 600 m/s to 1000 m/s, and a mean temperature of about 2,600° C. to about 3,800° C., more preferably between 2,750° C. and 3,300° C., and in the best example below, between 2,880° C. and 3,080° C.

The substrate may be cooled using frontside and/or backside cooling, for example to maintain the temperature below 700° C. or less.

The substrate may be an electrode of a SOFC, in which case the coating serves as an electrolyte.

By this method a coating can advantageously be produced having no open porosity and a closed porosity below 1%, and preferably below 0.5%, to reduce gas leakage across the layer. Furthermore the coating may have virtually no cracks. Gas tightness may be important in some applications. For example coatings may have a gas leakage rate measured with Helium gas at 1 psi differential pressure across the coating below 0.15 L/min/cm², and preferably below 0.1 L/min/cm².

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic representation of a high velocity low temperature thermal spray apparatus used in accordance with an embodiment of the invention;

FIG. 2 is a graph of samarium doped cerium oxide (SDC) particle states in a spray jet as a function of distance from the gun exit in terms of particle temperature and velocity in the specific apparatus used in the examples of the present invention;

FIG. 3 is a top-view photograph of a rectangular SOFC fuel cell component with the dimension of 50×50 mm, 1.25 mm thick, consisting of a Hastelloy X substrate, a nickel oxide—SDC anode and a SDC electrolyte produced by an exemplary process of this invention;

FIG. 4 is a scanning electron micrograph taken at a 500 times magnification of the cross-section of a SOFC button cell component of the same construction as the SOFC component of FIG. 3;

FIG. 5 is a scanning electron micrograph taken at a 5,000 times magnification of the cross-section of the button cell component of FIG. 4;

FIG. 6 is an X-Ray diffraction pattern of a SDC electrolyte coating of the button cell component of FIG. 4;

FIG. 7 is a graph showing current-voltage and power density characteristics for the fuel cell consisting of button cell of FIG. 4 on which a samarium strontium cobaltite cathode is applied operated at temperatures between 500 and 700° C.;

FIG. 8 is a scanning electron micrograph taken at a 500 times magnification of a cross-section of a SOFC fuel cell of FIG. 7 after performance and thermal cycle testing (14 cycles between 25° C. and 600° C. at 60° C./min heating rate);

FIG. 9 is a top-view photograph of a circular SOFC button cell fuel cell component with a diameter of 16 mm, 1.25 mm thick, consisting of a Hastelloy X substrate, a nickel oxide—SDC anode and a SDC electrolyte produced by suspension plasma spraying;

FIG. 10 is a scanning electron micrograph taken at a 1,000 times of a cross-section of the button cell shown in FIG. 9;

FIG. 11 is a scanning electron micrograph taken at a 5,000 times magnification of the cross-section of the button cell shown in FIG. 9;

FIG. 12 is a graph showing current-voltage and power density characteristics for the fuel cell consisting of the button cell shown in FIG. 9 covered with a samarium strontium cobaltite cathode operated at temperatures between 400° C. and 700° C. with hydrogen and air;

FIG. 13 is a scanning electron micrograph taken at a 150 times magnification of the cross-section of a fuel cell of FIG. 12 after performance and thermal cycle testing;

FIG. 14 is a graph of particle states in a spray jet as a function of standoff in terms of SDC particle temperature and velocity in a HVOF thermal spray apparatus using suboptimal parameters in comparison with those of FIG. 2;

FIG. 15 is a scanning electron micrograph taken at a 5,000 times magnification of the cross-section of a SDC coating on a stainless steel 430 substrate;

FIG. 16 is a scanning electron micrograph taken at a 500 times magnification of the cross-section of a SDC coating on a stainless steel 430 substrate;

FIG. 17 is a scanning electron micrograph taken at a 10,000 times magnification of the cross-section of a SDC coating produced with submicron sized particles on a mild steel substrate; and

FIG. 18 is a scanning electron micrograph taken at a 1,000 times magnification of the cross-section of the SDC coating shown in FIG. 17.

### DESCRIPTION OF PREFERRED EMBODIMENTS

It has been surprisingly found that injecting submicron- to nano-sized ceria-containing particles suspended in a combustible organic solvent into a plume having a temperature between about 2,600° C. and 4,000° C. produces a thin, uniform, dense, crack-free, nanocrystalline ceria-based coating, which may be applied on porous cermet or metal substrate, for example. The plume within this temperature range preferably imparts onto a resulting spray jet a mean temperature of from about 2,600° C. to about 3,800° C. which has been demonstrated to sufficiently melt a substantial proportion of the particles, and to accelerate the particles to a mean velocity between about 600 to 1000 m/s. The physical environment of a high-velocity oxy-fuel (HVOF) thermal spraying gun suitably deployed using standard fuels produces these conditions. The method of the present invention is particularly useful for the cost-effective fabrication of ceria-containing electrolytes for solid oxide fuel cells (SOFCs).

While not wanting to be limited by the following theory, it is postulated that the relatively low temperatures of the spray jet in the range of 2,600-3,800° C., barely above or below the melting point of pure ceria, sufficiently melted enough of the of spray jet to permit decent deposition rates because of substantial contributions from at least some of the following: dopants such as Nb, Ta, Gd, and Sm are known to reduce the melting point of the ceria by different amounts in comparison with pure ceria; the relatively high surface area of the particles provides a relatively large thermal interface for exchanging heat with the plume, in comparison with larger particles; the small volume of the particles permits less heat to completely melt the particles; the size of the particles may further reduce the intrinsic melting point of the particles in comparison with that of the bulk material according to the quantum size effect; the combustible organic solvent intimately in contact with the particles burns to supply a heat greater than the latent heat of vaporization and accordingly supplies localized heat to the particles; and the length of the plume extending substantially from the combustion chamber to the substrate provides for reduced cooling times after the spray jet exits the plume and a prolonged entrainment within the plume.

The examples below demonstrate a reproducible, relatively high deposition rate, thermal spray process using the identified thermal regime.

While advances in thermal spray technologies are ongoing, and while plasma plumes can be made exceedingly hot, it is noted that they generally have very small (a few centimeters) spatial extent (unless produced in a vacuum), and accordingly it has not been found possible to heat a spray jet to an average temperature of 2,600-3,800° C. with a plasma torch, nor has it been found possible to operate a plasma torch having a maximum temperature of 2,600-4,000° C. The HVOF gun used in the examples has a plume extending from a combustion chamber through a barrel and beyond, having a spatial extent of at least 20 cm.

It has surprisingly been found that high density (low porosity) and highly uniform, thin, ceria-based coatings can be applied without traversal cracks or pin holes (i.e. breaks in the coating that run in a direction substantially normal to the substrate surface) that may occur with the deposition of the particles using plasma spraying. While not wanting to be limited by the following explanation for this coating property is posited.

The relatively low temperatures of the spray jet in accordance with the present invention, permits a fraction of the spray jet to not substantially melt. The high velocities of this insufficiently melted fraction arrive at the substrate/coating and serve to peen the surface. This peening provides local plastic deformation of the cooling coating, which is considered to have significant effects on the intrinsic stresses in the coating. The shrinkage of the coating material due to solidification and thermal contraction during cooling, which is understood to lead to the detrimental crack formation in the coating, is compensated by this plastic deformation. Evidence of the peening is provided by the smoothness of the coating surface akin to grit blasting. The insufficiently molten fraction appears to need to be limited to ensure adherence as if the fraction is too high (i.e. the mean temperature of these particles is too low) the coating is effectively grit blasted resulting in the effacement of the coating at a rate that approaches the rate of deposition.

Furthermore it is believed that overheating of ceria-based powders (i.e. heating to temperatures near their boiling point) have numerous consequences, as explained by S. Sodeoka et al. in a paper entitled “Thermal and mechanical properties of ZrO₂—CeO₂ plasma-sprayed coatings” (Journal of Thermal Spray Technology, Vol. 6 (3) 1997, 361-367). If ceria-based materials are exposed to high temperatures, chemical reduction of the cerium from Ce⁴⁺ to Ce⁺³ can occur through the loss of oxygen, resulting in the formation of Ce₂O₃ along with the typically strongly reducing atmosphere in a plasma plume. Ce₂O₃ is an electrically conducting material, which is known to reduce the performance of the electrolyte. Ce₂O₃ is somewhat fragile and occupies a different specific volume than CeO₂, and can therefore interfere with the mechanical integrity and uniformity of the coating. Moreover, as Ce₂O₃ melts at 1,690° C. (whereas CeO₂ melts at about 2,750° C.), Ce₂O₃ also evaporates at substantially lower temperature than CeO₂. The overheating in the plasma flame may then causes a non-negligible portion of the ceria to evaporate, which reduces the deposition efficiency.

Furthermore, the plumes of plasma torches are strongly reducing environments that encourage the stripping of oxygen from the particles. The plume is therefore preferably a much less reducing environment. Fortunately the HVOF gun can even operate with a surplus of oxygen relative to that consumed by the fuel(s) combustion to inhibit the reduction reaction.

In any case, it has been found that using flames having maximum temperatures below 4,000° C., and more preferably below 3,800, 3,500, 3,300, or 3,200° C. results in good quality coatings.

FIG. 1 schematically illustrates an apparatus useful for applying the process of the present invention. The design and equipment choice is principally dedicated to deliver a uniformly dispersed submicron- to nano-scale ceria particle suspension feedstock to a plume having a temperature between about 2,600° C. and about 3,500° C. at a precise rate, in which the particles are heated and accelerated, and to avoid any malfunction of the equipment due to the suspension feedstock. The apparatus includes a torch 1, which may be commercially available HVOF gun, to which a fuel supply 2, for supplying a liquid fuel such as kerosene and propylene, or a gaseous fuel such as ethylene, propane or hydrogen, oxygen supply 3 and air supply 4 are delivered. The fuel supply 2, oxygen supply 3 and pressurized air supply 4 lead to a combustion chamber 5 where the fuel is ignited to form a high-velocity super-sonic combustion flame 6, which provides the plume in the illustrated embodiment.

The suspension feedstock is supplied to the combustion chamber 5 though a suspension supply tube 7 concentrically enclosed by an annular coolant feed tube 9. The outer diameter of the suspension supply tube 7 may be chosen to fit inside a standard powder feeding tube of a standard commercially available torch. The coolant feed tube 9 supplies an inert gas such as N₂ to the combustion chamber. The inert gas serves to cool the suspension injection tube and gas distributor of the torch 1 and to control properties of the torch 1 during operation.

The suspension is propelled into the combustion chamber 5 under fluid pressures, where the organic carrier combusts with the oxygen and fuel and the solid content of the suspension is precipitated into small particles, which tend to melt or partially melt while in contact with the flame 6, and are accelerated to form a spray jet. The combustion chamber 5 is in fluid communication with a barrel 16 which exits the torch 1 at a nozzle. The flame's 6 confinement to the combustion chamber 5 and the barrel 16 leads to an extended travel time during which the spray jet is heated and accelerated. When the burning gases are ejected through the nozzle, combustion is continuing and the flame is traveling at a substantial velocity, carrying the spray jet. The duration of the particles within the flame may permit the particles to nearly match the temperature of the flame.

The spray jet of heated and accelerated particles impact on the substrate 10 to form the coating 11. The mean temperature of the particles is substantially at or somewhat above the melting point of the ceria used, and is not overheated prior to contact with the surface.

The spray jet continues to be heated while it remains in the plume of a thermal spray apparatus, and rapidly cools thereafter. The combustion flame of an HVOF gun therefore provides for heating from the point the suspension is fed into the chamber throughout the acceleration through the barrel, and after discharge throughout the length of the projected flame. The flame of the spray jet can extend up to 30 cm from the nozzle of the HVOF gun. In contrast, plasma plumes are very small, extending only a few cm from the nozzle. Throughout the travel between the end of the plume and the substrate, the particles rapidly cool. In order for the spray jet to retain sufficient heat to remain sufficiently molten upon striking the substrate to produce a coating, the spray jet must be overheated in the plume, which is problematic for ceria-based coatings. For the same reason, the substrate has to be placed close to the plasma flame (plume) to reduce the travel time of the spray jet available for cooling and deceleration.

Consequently using an HVOF gun, instead of the plasma torch, the standoff distance between the exit of the barrel of the torch 1 and the substrate 10 can be significantly longer. This permits the spray jet to be deposited at a temperature and velocity that may be nearly maximal, rather than in close proximity to the high intensity heat source of a plasma. Using the HVOF gun may improve deposition efficiency and coating quality. In any case, it has been found that the particles are preferably deposited on the substrate at a standoff where the mean velocity in the spray jet would otherwise be above 600 m/s. Depending chiefly on the size distribution and composition of the ceria-based particles, a temperature of at least 2,600° C. is required in order to achieve a good deposition efficiency and coating quality. More preferably, especially if SDC is used, a temperature above 2750° C. would be preferred.

FIG. 1 also shows a feed delivery apparatus consisting of a suspension vessel 12, which is equipped with an agitator 13 to prevent sedimentation in the vessel and ensure homogeneity of the solid content, a flow measurement and dosing system 14, and a washing system 15. While it is widely known that nanoparticles have a tendency to aggregate and it is known that monodispersion is an exceedingly difficult condition to obtain, in general the higher the uniformity of distribution of the nanoparticles in the suspension, the more uniform the delivery, and the more likely that smaller volume precipitates will be produced by the atomization and solvent evaporation within the chamber. Accordingly the spray jet will include more of the smaller, more fully melted droplets which are entrained in the combustion flame, and are believed to be essential to providing the deposition efficiency and coating quality.

Given the theory posited above, it is reasonable to infer that a size distribution of the powder that is substantially bimodal, with a substantial part being nanoscale powders less than 50 nm and more preferably less than about 30 nm or 20 nm as is used below would provide the substantially molten droplets that provide the adhesion and larger diameter fraction that is expected to substantially peen the substrate or impact the substrate with a higher inertia to densify the coating. The larger fraction may be constituted of monolithic nano- to submicron-scale particles, or may be nanostructured agglomerates. In the later case a higher surface area to volume ratio would be expected favouring increased probabilities of sufficient melting and incorporation of the larger fraction into the coating in comparison with the former, which would increase a deposition efficiency.

Naturally the combustion chamber produces a considerable pressure. The delivery of each fluid to the combustion chamber must overbear this pressure, while maintaining controlled delivery, including the suspension. This can be achieved by using pump based systems such as that described in Applicant's U.S. application Ser. No. 11/410,046 and International Patent Application PCT/CA2006/000651, or by pressurizing the feedstock to a pressure higher than that of the combustion chamber, as described in the paper to Killinger et al. identified above, the totality of which is incorporated herein by reference. In the examples provided, the method of Killinger et al. is adopted, using essentially a Nanofeed Liquid Powder Feeder Model 650 from Northwest Mettech Corp. (North Vancouver, BC, Canada).

Suspension delivery systems are able to deliver with feed rates between 0.01 and 10 kg/hr, and to maintain constant and adjustable feed rates for the duration of a coating process. Such delivery systems may be fully automated and have automated washing and rinsing cycles to clean the delivery lines in between deposition runs. Furthermore, the suspension delivery system can provide the preferred suspension feed rate of 0.5 kg/hr to 5 kg/hr, more preferably 1.5 kg/hr to 2.5 kg/hr against the backpressure in the combustion chamber, which can reach or exceed 100 psi.

In operation, HVOF thermal spray guns are known to use either liquid fuel such as kerosene and propylene, or gaseous fuel such as ethylene, propane or hydrogen to combust with pure oxygen and air at flame temperatures between 2,500° C. and 3,200° C. Suspended feedstock particles injected into the combustion chamber are precipitated out by the vaporization and combustion of the combustible organic solvent to produce a spray jet that is heated and melted while accelerating with the plume to exit the gun nozzle at high velocities.

The spray jet then impact on a substrate that is usually positioned substantially orthogonally to the velocity of the spray jet at some distance (standoff) downstream from the gun exit nozzle to form the thermal spray coating. Maximum temperatures of the particles in the HVOF spray process depends on the spray gun design as well as on the feed rate, morphology and size distribution of the powder particles, oxygen to fuel ratio as well as position within the spray flame.

It should be pointed out that for HVOF spraying of submicron- to nano-sized ceria particles in accordance with the invention, the maximum particle temperature (e.g. between 2750° C. and 3300° C.) is reached outside and downstream from the gun exit nozzle, such that the particle can be deposited on the substrate in or close to their hottest state during their flight history. A fortiori no earlier overheating has taken place.

It should further be pointed out that for HVOF spraying of submicron- to nano-sized ceria particles in accordance with the invention, the particles are accelerated to high velocities above 600 m/sec, reaching 700-1000 m/sec close to the gun exit nozzle.

Feeding submicron or nano-sized particles into a thermal spray gun with conventional powder feeding equipment is known to be difficult or impossible due to the strong powder agglomeration, which impedes powder flowability. Suspending the small particles in a liquid carrier, which is then injected into the HVOF gun, and can therefore alleviate this problem and allows for more precisely controlled feeding rates of the feedstock.

Ceria-containing electrolyte coatings according to the invention are produced from suspended ceria-containing submicron- to nano-sized particles, which may have a mean particle size below about 100 nm, preferably below about 60 nm, more preferably below about 20 nm, corresponding to a specific surface above 80 to 220 m²/g. The particles are composed of cerium oxide, preferably doped or admixed with another oxide to enhance the ionic conductivity. For example, Nb, Ta, Gd, Sm, Y, Ca, or Sr and preferably gadolinium oxide or samarium oxide may be used. Examples of compositions of solid electrolytes having oxide-ionic conduction includes (CeO₂)_{0.8}(YO₁₅)_{0.2}; (CeO₂)_{0.9}(SmO_{1.5})_{0.1}; (CeO₂)_{0.8}(CaO)_{0.2}; (CeO₂)_{0.8}(SrO)_{0.2}. The ceria-based powder has a general formula of (CeO₂)₁₋ₓ(SmO_{1.5})ₓ, where x is preferably about 5-25 mol %, more preferably 15-20 mol %. A commercially available example of a suitable nano-sized powder is produced by nGimat™, Atlanta, Ga., USA.

Using a combustible organic solvent carrier, such as for example ethanol or ethylene glycol or a mixture of ethanol and ethylene glycol, into which the nano-sized particles are suspended, additional fuel for the combustion in the HVOF gun is provided to further increase the particle temperatures. The powders according to the invention are suspended in a combustible organic solvent, which may be ethanol, ethylene glycol or the like. Two or more solvents can be mixed. As such, the solvent poses a low thermal load on the flame, or even contributes to its heat. The ethylene glycol appears to chemically disperse the powders used, especially when included at about 75%.

The suspensions may be prepared with a mixture of less than 20 solid wt. %, preferably less than 5 wt. %, and in the best example 2 and 3 wt. % of solids is used, ensuring only small amounts of molten ceramic exit the gun at a time, which has been observed to increase the average particle temperature and to be beneficial for the coating formation.

To prevent solid sedimentation, the suspensions can be prepared using any one of a wide variety of dispersants. The person of ordinary skill in the art will choose a dispersant a view to optimally dispersing the particles in the particular organic solvent used. For example, polyethyleneimine, available by Alfa Aesar, USA could be used because a cationic polyelectrolyte was found to work in this system.

The coating can be applied in a wide range of thicknesses. For use in a SOFC, the thickness is preferably less than 100 μm, more preferably less than 80 μm, more preferably less than 70, 60, or 50 μm. Coatings have been produced with about 20 μm thicknesses. Uniform thickness coatings of between 5 and 25 μm are contemplated by variation of the parameters to provide a favourable SOFC electrolyte. A thin and nanostructured electrolyte layer can compensate for the reduction of ionic conductivity at lower temperatures by decreasing the traveling distance of oxygen ions and enhancing the mobility of the ions along the grain boundaries. Since the electrolyte thickness is inversely proportional to the oxygen ion flux through the electrolyte, the thin electrolyte has the advantage of lower ohmic resistance during cell operation.

The electrolyte should have no open porosity and a closed porosity below 1%, and preferably below 0.5%, to reduce gas leakage across the layer. Furthermore the electrolyte should have virtually no cracks that permit reactant gases to pass through the electrolyte during operation of the cell. Gas tightness is important to attain a high voltage of the cell and reduce degradation due to hot regions created by the combustion of gases which would pass through cracks or pinholes in the electrolyte during operation of the fuel cell. For example, a gas leakage rate measured with Helium gas at 1 psi differential pressure across the electrolyte area should be below 0.15 L/min/cm², preferably below 0.1 L/min/cm².

While the examples and parameters below are all provided using a particular HVOF gun, it will be appreciated that the person of ordinary skill in the art will be able to achieve equivalent results using analogous equipment with corresponding operating parameters to achieve flames within the temperature range provided to impart the desired temperature and velocity to the sub-micron to nano-sized particles.

The following non-limiting examples demonstrate the method for the production of the ceria-based coating and show its performance as an electrolyte for a reduced temperature SOFC.

### Example 1

### HVOF Sprayed Electrolyte

### Apparatus

A thermal spray apparatus, as shown in FIG. 1 was assembled. A commercially available HVOF gun used (model number DJ-2700, Sulzer-Metco, Westbury, N.Y., USA) is capable of generating supersonic flame velocities and sufficiently high temperatures.

The DJ-2700 gun has a stainless steel tube inserted into the 1.5 mm inner diameter feedstock supply tube throughout its length so that the stainless steel tube had an opening flush with the opening of the feedstock supply tube at the combustion chamber. The stainless steel tube was a 19 gauge tube having an outer diameter just over 1 mm, and an inner diameter of about 0.8 mm, although other arrangements that do not provide excessive resistance to both the coolant and the feedstock suspension flows would be expected to work equally well. This is how the inert gas and feedstock suspension were supplied to the DJ-2700 gun.

The suspension of 2.5 wt. % solids in a 3:1 mixture of ethylene glycol to ethanol was prepared from nanosized (˜20 nm particle size) samarium doped ceria (SDC) (specifically (CeO₂)_{0.8}(SmO_{1.5})_{0.2}) and dispersed in a two-frequency ultrasonic bath at 16 and 80 kHz, with the addition of a dispersant at a quantity corresponding to 0.5 wt % of powder polyethyleneimine, obtained from Alfa Aesar, USA. The suspension was mechanically agitated for at least 12 hrs. The suspension was injected into the DJ-2700 at a flow rate of 33.3 mL/min with a computer controlled flow control loop from a pressurized canister maintained at a pressure of 150 psi.

Experimental conditions were as follows:

| | |
|---|---|
| Propylene flow | 75 slpm |
| Oxygen flow | 279 slpm |
| Air flow (shroud) | 202 slpm |
| Nitrogen flow | 15 slpm |

### Spray Jet Particle Ranking

On-line measurements of the particle states in the spray jet were performed using commercially available particle diagnostic equipment (Accuraspray G3, Tecnar Automation, St. Bruno, Quebec, Canada).

These measurements indicated that the highest average particle temperature (2980±100° C.) was reached with a standoff distance of between about 14 and 16 cm from the gun exit nozzle where the average particle velocity slows to about 700-600 m/sec.

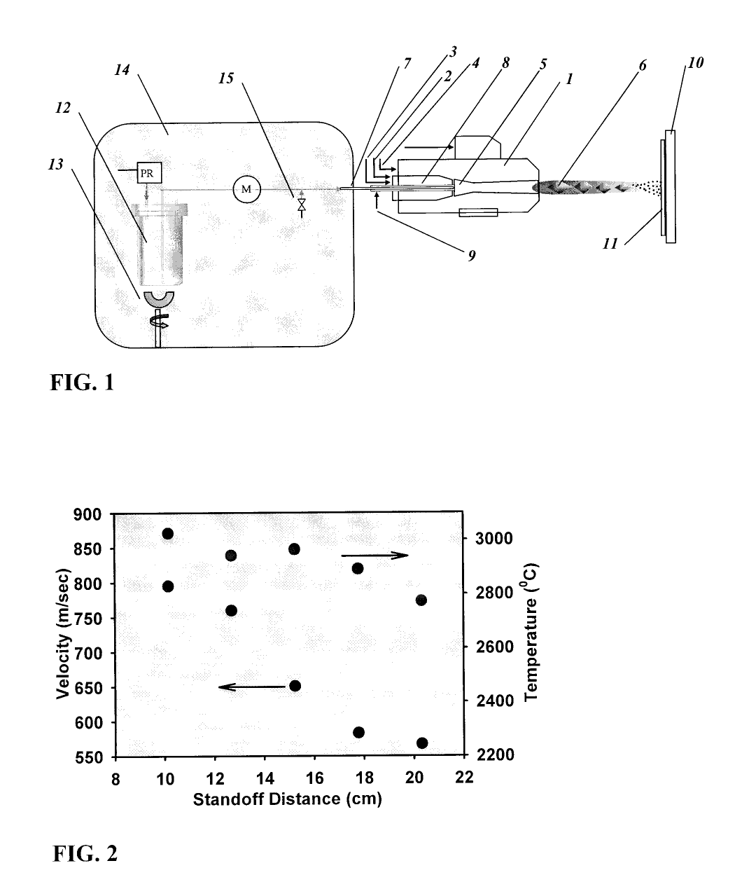

FIG. 2 is a graph that shows the average particle velocity and temperature as a function of standoff. The graph illustrates that indeed the highest particle temperature is attained downstream of the gun exit nozzle. Based on this measurement, a standoff distance of 127 mm was chosen for a substrate. The 127 mm standoff distance was particularly chosen because it is about 2.5 cm before the maximum temperature standoff.

The flame properties at a given standoff and thus the spray jet properties are altered significantly by the presence of the substrate. The sheath gas, spray jet and plume are all affected by the obstacle. The gases are entirely deflected. As the precipitated solids are light enough to be entrained by the gas in order to produce the spray jet in the first place, a significant part of the spray jet will slow significantly (in the direction of the surface normal) and lose heat in the process. For this reason a sufficient inertia to the spray jet is important to permit these to land on the surface of the coating/substrate.

A minimum velocity of about 600 m/s is considered important for ensuring deposition at a high enough rate to provide a coating in accordance with this invention. It is expected that a standoff distance between 11.5 cm and 16 cm could be used to achieve substantially similar coatings, as shorter standoff distances would provide particles that aren't hot enough (for these particles so dispersed and sized), and would also increase thermal stresses on the substrate, and any longer standoff distances would not provide sufficient inertia to strike the substrate.

It should be noted that the temperature trend is more accurately identified than the absolute temperatures measured using this equipment. The trend is confirmed by the deposition rates at standoff distances that are close to the maximum temperatures attained, which must be at or above the melting point of the particles. The maximum mean temperature of the spray jet was observed to be 2980° C.+/−100° C.

It should further be noted that the graph shows only the points that are well suited to the deposition of SDC of a particle size distribution of than 20 nm in the apparatus under the illustrated mode of operation. A hotter/cooler fuel, different fuel delivery rate, smaller mean particle size, or a different dopant will be expected to change the mean temperature of the particles required for deposition. It is believed that useful deposition rates can be achieved with finer sized doped particles at temperatures as low as 2,600, and that useful coatings can be provided by raising the temperatures of the particles as high as 3,800, for example, if larger particles of undoped ceria are used.

### Sample Preparation

A SDC electrolyte of approximately 20 μm thickness was deposited on a porous, 70 micron thick suspension plasma sprayed anode, composed of 50 wt. % nickel-oxide and 50% wt. SDC. The electrolyte can also be deposited onto an air electrode and used in a planar or tubular fuel cell, for example. The anode, in turn, was supported by a metallic Hastelloy X substrate with a porosity of 27.5% and a pore size of about 10 μm. The electrolyte was produced using the DJ-2700 and apparatus as described above.

The substrate was retained on a cooled substrate holder adapted to the substrate dimensions. The substrate holder was a planar plate having dimensions substantially larger than the substrate and the spray jet, combustion flame, and sheath gases so that an obstruction of an infinite plane is presented. During deposition, the substrate temperature was maintained at about 450° C. using backside air and water cooling, as well as forced-air cooling at the front side of the substrate holder.

To deposit the coating, the gun was moved in a ladder pattern in 2.5 mm steps horizontal to the substrate at a scan speed of 760 mm/second and repeated 60 times, i.e. 60 passes at the standoff distance of 127 mm from the substrate.

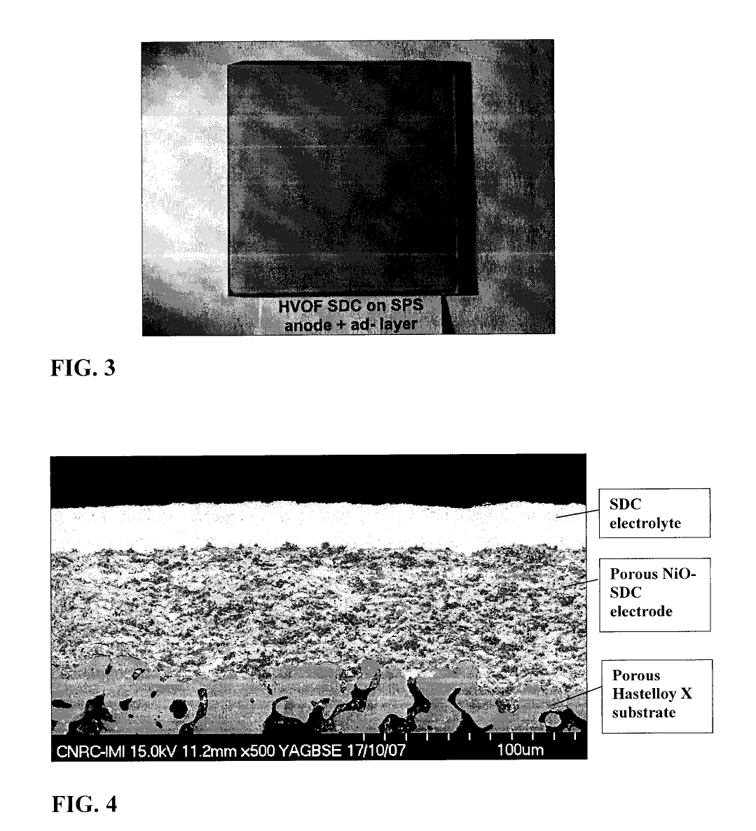

In this manner, a substrate having a circular disk geometry of 16 mm diameter was coated. Electrolyte coatings were also produced on larger substrates with rectangular dimensions of 50×50 mm without introducing any distortion of the substrate during spraying or any optically visible defect in the electrolyte coating. For the larger 50×50 mm substrates, the electrolyte coating was produced in 16 minutes, consuming 13.3 g of (solids) SDC powder material. A deposition efficiency of approximately 50% was attained. FIG. 3 is a photograph of the 50×50 mm half-cell after electrolyte deposition.

### Micrographic Imaging

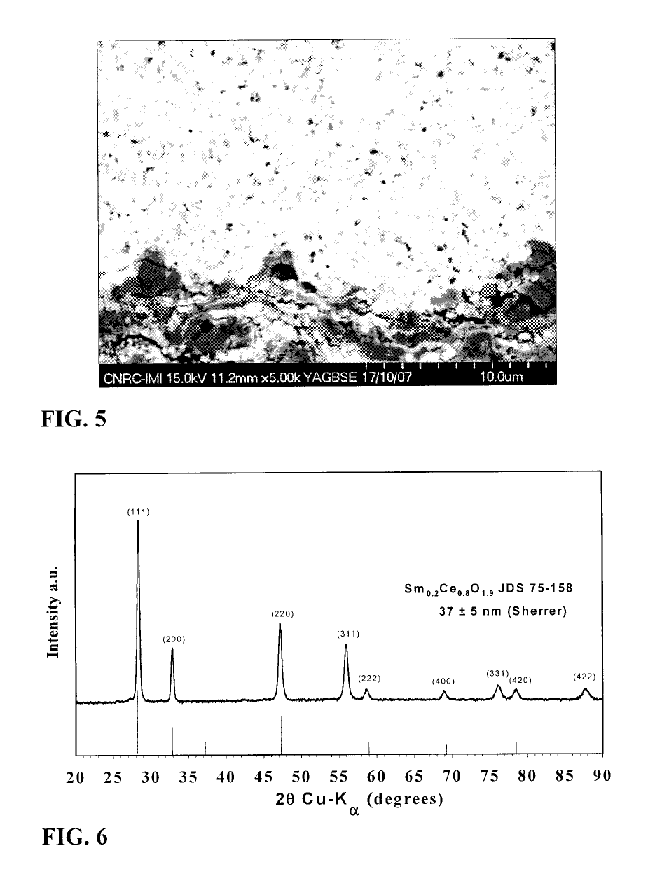

FIGS. 4 and 5 are micrograph images of the button cell of example 1 showing the uniform microstructure of the electrolyte layer taken at 50 and 500 times magnification, respectively. The cross-section was obtained by vacuum impregnating the sample with epoxy, dicing the impregnated button cell with a metallurgical diamond blade saw, mounting the sample in an epoxy disk and then polishing the cross-section with consecutively refining polishing media up to 0.05 micron diamond paste.

The electrolyte has a thickness between 60 and 75 microns, and is of very uniform thickness, given the roughness of the substrate. The electrolyte has no major defects and has a relatively smooth surface finish, which facilitates further processing steps, such as the subsequent deposition of an air electrode. The electrolyte layer material appears well fused, and no distinct lamellar structure can be discerned. The electrolyte layer is in close contact with the rough surface of the underlying fuel electrode thereby ensuring sufficient electrical contact and adhesion.

Electron microscopy on the cross-section of the coatings revealed a highly dense micostructure, free of cracks and without any visible lamellar structure, as shown in FIG. 5. A pronounced lamellar structure is usually associated with thermal spray coatings by virtue of the overlapping droplets from which it is formed. A porosity <1% was determined using image analysis on the micrograph. Besides some closed porosity, the micrograph in FIG. 5 shows only few regions of gray contrast, which are representative of pull-out and fracture surface created during the polishing step. This serves as an indication of a high degree of material fusion and coating quality.

### X-Ray Analysis

X-Ray Diffraction (XRD) analysis indicated that the coatings consisted exclusively of cerianite (CeO₂) of a fluorite crystalline structure. The nanostructure of the coatings was confirmed by the peak broadening of the XRD spectra, indicating a grain size of below 50 nm. An exemplary XRD spectrum is depicted in FIG. 6.

### Gas Tightness Testing

Gas tightness is important to attain a high voltage of the cell and reduce degradation due to hot regions created by the combustion of gases which would pass through cracks or pinholes in the electrolyte during operation of the fuel cell. A gas leakage rate measured with Helium gas at 1 psi differential pressure should be below 0.15 slpm, preferably below 0.1 slpm.

The produced half cells (metal interconnect-anode-electrolyte) were subjected to a gas leak test, using helium at 1 psi differential pressure. In this rest the cell is sealed on the electrolyte, using o-rings, and helium pressure is applied to one side, while the gas flow through the electrolyte is recorded by a mass flowmeter. The electrolyte had a measured low gas permeability of 0.085 slpm/cm².

### SOFC Construction

After electrolyte deposition, a composite cathode consisting of samarium strontium cobaltite (SSCo) and SDC (70 wt % SSCo) was applied to the electrolyte by stencil printing. The composite cathode was in situ fired at 800° C. for 2 h. NiO-SDC anode was reduced at 650° C. with 10% H₂ (Nitrogen as balance gas) for 90 min, 20% H₂ for 60 min, 50% H₂ for 30 mins, 100% H₂ for 120 mins. All the mixed gas was humidified at room temperature.

### SOFC Performance

The button cell performance and electrochemical impedance spectra were tested from 500° C. to 700° C. in 50° C. intervals.

Exemplary performance of this button cell is shown in FIG. 7. A maximum power density of The 0.92 W/cm² at 700° C. was attained. At 600° C. the cell shows a maximum power density of 0.5 W/cm². This is an exceptionally high value for a metal supported SOFC operated at reduced temperatures and underscores the quality of the coating.

### Thermal Cycling

The button cell was thermally cycled between 60° C. and 600° C. at a 60° C./min heating rate for 14 cycles.

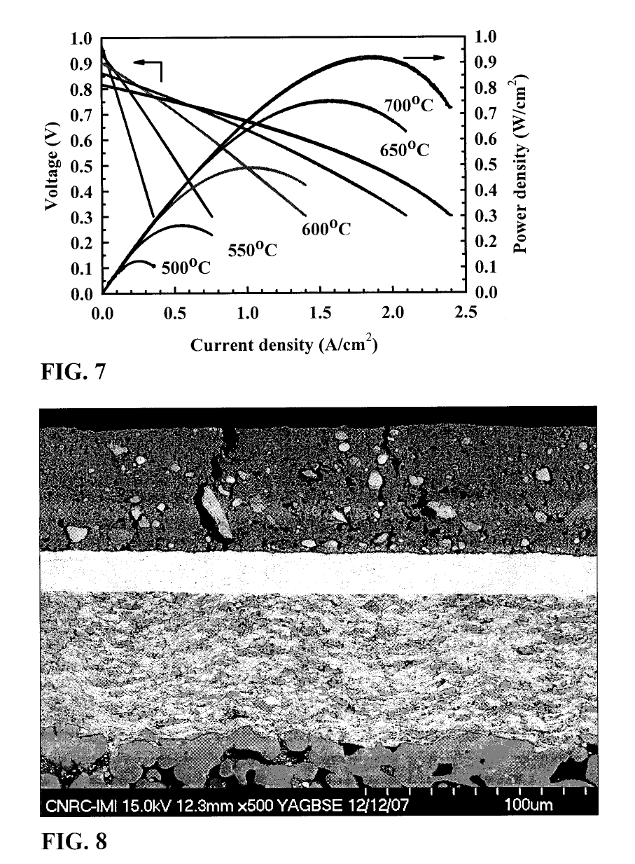

After cycling the microstructure of the electrolyte of the fuel cell is substantially unaltered as shown in the micrograph of FIG. 8. On the other hand, changes in the anode and cathode microstructure, as well as at the interface between the components lead to significant performance degradation of the SOFC.

### Example 2

### Plasma Sprayed Electrolyte

### Apparatus

In this example, a SDC electrolyte of approximately 27 μm thickness was fabricated by suspension plasma spraying using an axial injection plasma torch (Axial III, Northwest Mettech Corp., North Vancouver, BC, CAN). The SDC electrolyte was deposited onto a porous, 25 micron thick suspension plasma sprayed anode, composed of 70 wt. % nickel-oxide and 30 wt. % SDC. The anode, in turn, was supported by a metallic Hastelloy X substrate with a porosity of 27.5% and a mean pore size of about 10 μm. As such the electrolyte is applied to a comparable surface as that of the electrolyte of example 1.

This example was first published in Dynamic Evaluation Of Low-Temperature Metal-Supported Solid Oxide Fuel Cell Oriented Towards Auxiliary Power Units (Z. Wang et al., Journal of Power Sources, Vol. 176, Issue 1, January 2008, 90-95).

For the electrolyte, the suspension of 5 wt % solids in ethanol was prepared from micron to sub-micron sized SDC particles (average particle diameter d₅₀<1.54 μm), and dispersed in a two-frequency ultrasonic bath at 16 and 80 kHz, with the addition of a dispersant. The suspension was injected into the center of three converging plasma streams inside the torch at a flow rate of 21.7 mL/min.

In such an arrangement, the suspension droplets are intimately contacted with the plasma flame (8000° C.-15,000° C.) to impart a high heat and momentum transfer, which was found to be beneficial for creating the densest and most defect free coatings. During deposition, the substrate surface temperature was maintained below 700° C. using backside air and water cooling, as well as forced-air cooling at the front side. Plasma torch operating conditions were as follows:

| Torch current (3X) | 200 | A |
|---|---|---|
| Total primary gas flow rate | 275 | slpm |
| Argon concentration | 75% | |
| Nitrogen concentration | 15% | |
| Hydrogen concentration | 10% | |
| Torch power | 91 | kW |
| Torch nozzle size | 9.53 | mm |

To apply the coating, the torch was moved in a ladder pattern in 3 mm steps horizontal to the substrate at a scan speed of 1016 mm/second and repeated 140 times, i.e. 140 passes at a standoff distance of 50.8 mm from the substrate.

The substrate had circular disk geometry of 16 mm diameter (button cell). The electrolyte coating was produced in 16 minutes, consuming 17.3 g of SDC powder material. A deposition efficiency of approximately 15% was attained.

The following differences between how the electrolytes were deposited in the first and second examples are noted: the change in the combustible organic solvent is expected to have little consequence in terms of the temperature of the plume because of the extremely high temperatures in the plasma torch, but is expected to impact the feedstock properties and in particular the uniformity of the dispersion, which are not expected to be as critical in the plasma thermal spray embodiment; the differences in scan speed and number of passes are also not expected to significantly impact on the quality of the electrolyte. The low deposition efficiency is the highest that was achieved, and using a smaller particle distribution, resulted in a lower deposition efficiency, as is consistent with the premise that Ce₂O₃ is vaporized in the process.

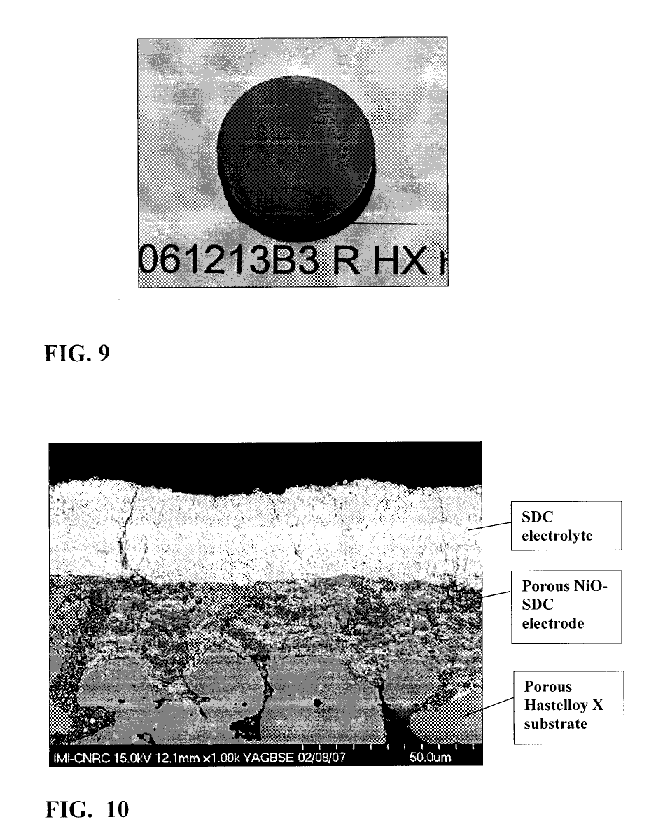

FIG. 9 shows a photograph of a button cell-cell after electrolyte deposition.

### Spray Jet Particle Ranking

Prior to spraying the coating, on-line measurements of the particle states were performed using commercially available particle diagnostic equipment (Accuraspray G3, Tecnar Automation, St. Bruno, Quebec, Canada). The measurement volume was centered in the spray plume at the location of the substrate during deposition, at the standoff distance of 50.8 mm. Due to interference with the optical diagnostic system by the output of the plasma torch, an indirect approach to ranking the particle states was adopted, using zirconia suspensions at the same spray conditions. An average in-flight particle velocity of 860 m/sec and temperature of 2950° C. was determined at the spray distance of 50.8 mm.

### Micrographic Imaging

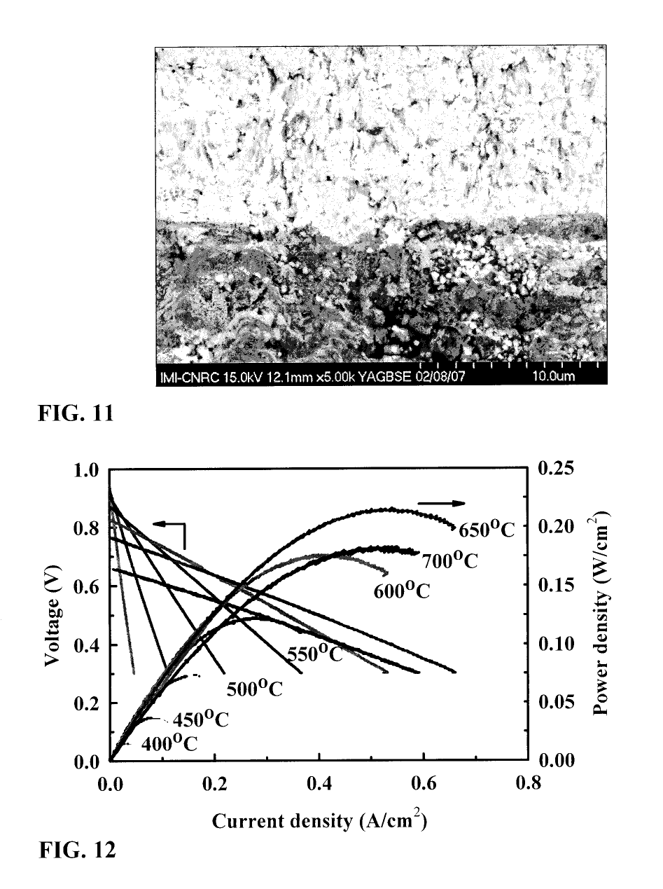

Electron microscopy on the cross-section of the coatings revealed a relatively dense microstructure, with some residual fine porosity and a few thin vertical defects, as shown in FIG. 10. A porosity as high as 2% was determined using image analysis on the micrograph. Besides some porosity, the micrograph in FIG. 11 shows some regions of gray contrast, which are representative of pull-out and fracture surface created during the polishing step. This can serve as an indication of some incomplete material fusion.

### Gas Tightness Testing

The produced half cells (metal interconnect-anode-electrolyte) were subject to a gas leak test, using helium at 1 psi differential pressure and showing a low gas permeability of 0.37 slpm/cm².

### SOFC Construction

After electrolyte deposition, a composite cathode consisting of samarium strontium cobaltite (SSCo) and SDC (75 wt % SSCo) was applied to the electrolyte by screen printing. The composite cathode was in situ fired at 800° C. for 2 h. NiO-SDC anode was reduced at 650° C. for 5 h while gradually introducing hydrogen. All the mixed gas was humidified at room temperature.

### SOFC Performance

The cell performance and electrochemical impedance spectra were tested from 400° C. to 700° C. in 50° C. intervals.

Cell performance is graphically represented in FIG. 12. A maximum power density (MPD) of 0.216 W/cm² with an open cell voltage (OCV) of 0.768 at 650° C. was attained. At 600° C., the cell showed a MPD of 1.76 W/cm². At 700° C. the cell showed a MPD of 0.183 W/cm². This performance is within the range of values reported for metal-supported SOFCs at the current state of the art. In comparison, example 1 provides 2-5 times the power density at the corresponding operating temperatures.

Having regard to the examples 1 and 2, it is surprising that such a significant change in the quality of the electrolyte and the material properties of the coating could be achieved by reducing the temperature of the thermally sprayed particles to near that of the melting point of the ceria-based particles.

### Thermal Cycling Tests

The SOFC was thermally cycled between 60° C. and 600° C. at a 60° C./min heating rate for 12 cycles.

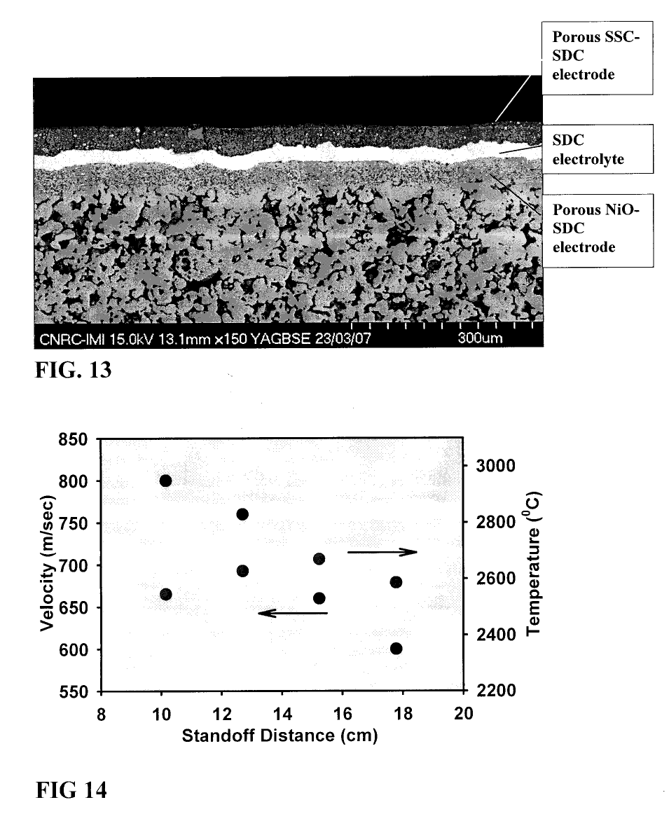

After cycling the microstructure of the fuel cell electrolyte is substantially unaltered as shown in the micrograph of FIG. 13. For much the same reasons as stated in relation to example 1, the SOFC performance was degraded by the thermal cycling.

### Example 3

### Suboptimal Fuel to Oxygen Ratio

A SDC coating of approximately 15 μm thickness was deposited on a stainless steel 430 substrate. For the coating, the suspension of 5 wt. % solids in ethanol was prepared from nanosized SDC (˜20 nm particle size). The suspension was injected into the DJ 2700 spray gun at a flow rate of 50 mL/min. During deposition, the substrate temperature was maintained at 420° C. using backside air and water cooling, as well as forced-air cooling at the front side. Experimental conditions were the following:

| | | |
|---|---|---|
| i. | Propylene flow | 80 slpm |
| ii. | Oxygen flow | 279 slpm |
| iii. | Air flow (shroud) | 202 slpm |
| iv. | Nitrogen flow | 15 slpm |

### Spray Jet Particle Ranking

Prior to spraying the coating, on-line measurements of the particle states were performed. These measurements indicated that the highest mean particle temperature of 2670° C.±100° C. is reached 15 cm after the gun exit nozzle at an average particle velocity of 660 m/sec. FIG. 14 shows a graph of the axial profile of average particle velocity and temperature for these spray conditions. A spray distance of 102 mm was chosen for coating production, for much the same reason as 127 mm was chosen in example 1.

### Electrolyte Deposition

To deposit the coating, the gun was moved in a ladder pattern in 2.5 mm steps horizontal to the substrate at a scan speed of 760 mm/second and repeated 20 times, at a standoff distance of 102 mm from the substrate.

The substrate was of the same dimension as for the previous button cell electrodes of examples 1 and 2, but was a sold stainless steel 430.

### Micrographic Imaging

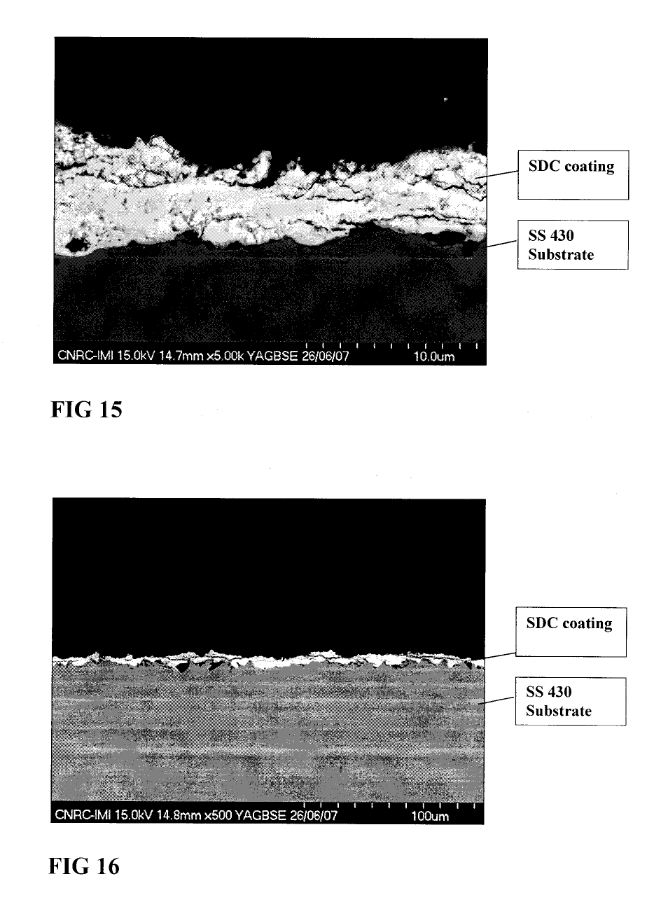

Electron microscopy of the cross-sections of the coatings revealed a fractured, non-continuous coating as shown in FIGS. 15 and 16. As such the coatings are unsuitable for an SOFC electrolyte application. Besides horizontal cracks, a large number of gray regions can be seen.

This microstructure indicates that the coating was formed from particles that were not sufficiently molten at impact to form a continuous coating. The small amount of deposited material remained on the substrate only by virtue of mechanical anchoring in the roughness asperities of the substrate. It is believed that the unacceptably high fraction of insufficiently molten particles in the spray jet is responsible for effectively grit blasting the surface resulting in a coating that is effaced as fast as it is deposited. This conclusion is in agreement with the particle temperatures measured being below or not sufficiently above the melting point of the ceramic, and below that of the example 1.

It is further noted that smaller particle sizes and other ceria-based compositions are expected to have lower melting points, and accordingly this thermal spray regime may be useful although the parameters used in example 1, where a substantially higher flame enthalpy is produced, may be preferred in general because the superheating of the droplets by a small margin (in comparison with the overheating that approaches the vaporization point of the ceria-based powder) so that a higher fraction of the spray jet melts in general is expected to improve deposition efficiency and coating quality.

It is therefore noted that too high a delivery rate of the solids content in relation to the fuel delivery rate, and a too high fuel delivery rate in relation to the oxygen flow, have the consequence of lowering the temperature imparted on the spray jet, which in this case has a negative impact on the deposition efficiency, and the quality of the coating.

### Example 4

### Suboptimal Particle Size

A samarium doped ceria coating of approximately 5 μm thickness was deposited on a mild steel substrate. For the coating, the suspension of 5 wt % solids in ethanol was prepared from sub-micron sized samarium doped ceria particles (average particle diameter d₅₀<1.54 μm). The suspension was injected into the HVOF spray gun at a flow rate of 50 ml/min. During deposition the substrate temperature was maintained at 380° C. using forced-air cooling at the front side. Experimental conditions were as follows:

| | | |
|---|---|---|
| v. | Propylene flow | 90 slpm |
| vi. | Oxygen flow | 279 slpm |
| vii. | Air flow (shroud) | 202 slpm |
| viii. | Nitrogen flow | 15 slpm |

To deposit the coating, the gun was moved in a ladder pattern in 2.5 mm steps horizontal to the substrate at a scan speed of 760 mm/second and repeated 10 times, at a standoff distance of 102 mm from the substrate.

The substrate had rectangular geometry of 25×75×12.5 mm.

A spray distance of 102 mm was chosen for coating production.

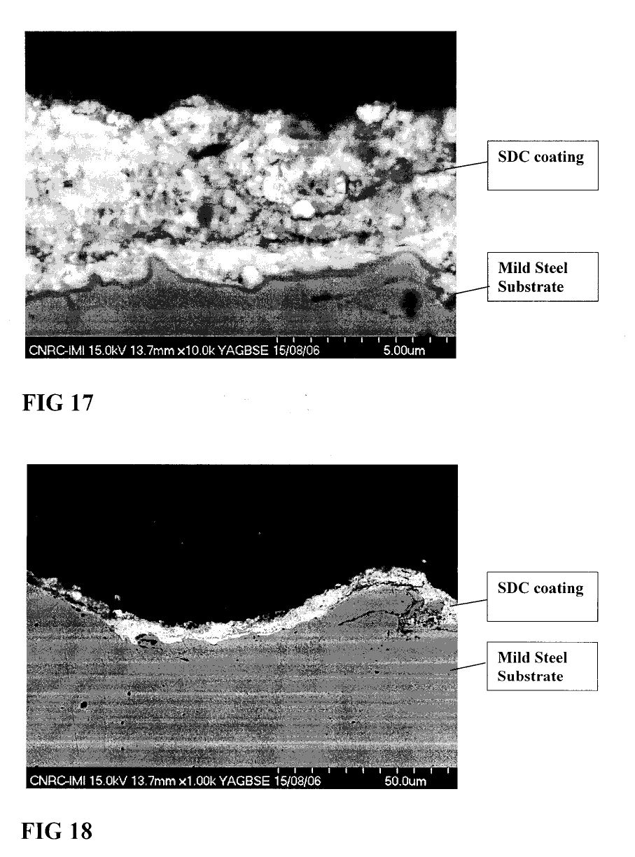

Electron microscopy on a cross-section of the coatings revealed a microstructure, which appears to be a loose aggregation of particles as shown in FIGS. 17 and 18. Such coatings are unsuitable for SOFC electrolyte applications. A large number of gray regions can be seen, which suggest a lack of particle melting and fusion in the coating. This microstructure indicates that the coating was formed from particles that were not sufficiently molten at impact to form a continuous coating.

It is therefore noted that a mean particle size has a significant impact on the microstructure of the coating. It will be appreciated that the conditions of examples 3 and 4 are substantially the same except for the additional fuel in example 4, and the use of a powder having a larger mean particle size. Despite the added fuel, a significantly worse coating is produced.

It will be further noted that the combustible organic solvent used in examples 3 and 4 did not contain the ethylene glycol and are expected to accordingly have reduced dispersion of the powder.

While a preferred embodiment has been shown and described, various modifications and substitutions may be made without departing from the spirit and scope of the invention. Accordingly, it is to be understood that the present invention has been described by way of illustrations and not limitations.

References: The contents of the entirety of each of which are incorporated by this reference.

### U.S. Patent Documents

| | | |
|---|---|---|
| 5,672,437 | September 1997 | Yajima et al. |
| 7,090,891 B2 | August 2006 | Anderson et al. |
| 6,579,573 B3 | June 2003 | Strutt et al. |
| 5,609,921 | March 1997 | Gitzhofer et al. |
| 5,234,722 | August 1993 | Ito et al. |
| 6,638,575 b1 | October 2003 | Chen et al. |

### PATENT APPLICATIONS

| | | |
|---|---|---|
| US 2005/0089739 A1 | 4/2005 | Seccombe et al. |
| PCT/CA2006/000651 | 4/2006 | Oberste Berghaus et al. |
| US2004/0058225 A1 | 3/2004 | Schmidt et al |

### OTHER PUBLICATIONS

J. Oberste Berghaus, J.-G. Legoux, C. Moreau, R. Hui, D. Ghosh, Suspension plasma spraying of intermediate temperature SOFC components using an axial injection dc torch, Material Science Forum, Trans. Tech. Publisher, Switzerland, Vol. 539-543, (2007) pp. 1332-1337.
J. Oberste Berghaus, J.-G. Legoux, C. Moreau, F. Tarasi, T. Chraska, Mechanical and thermal transport properties of suspension thermal sprayed alumina-zirconia composite coatings, Journal of Thermal Spray Technology, JTST 17(1) March 2008.
Killinger, M. Kuhn, R. Gadow, High-velocity suspension flame spraying (HVSFS), a new approach for spraying nanoparticles with hypersonic speed, Surface & Coatings Technology 2001 (2006) 1922-1929.
R. Gadow, A Killinger, A. Candel Ruiz, H. Weckmann, A. Öllinger, O. Patz, Investigation on HVOF-Technique for Fabrication of SOFCs Electrolyte Layers, Thermal Spray 2007: Global Coating Solutions, ASM International, Materials Park, Ohio, USA pp. 1052-1058.
Z. Wang, J. Oberste Berghaus, S. Yick, C. Decès-Petit, W. Qu, R. Hui, R. Maric, D. Ghosh, Dynamic evaluation of low-temperature metal-supported solid oxide fuel cell oriented to Auxiliary Power Units, Journal of Power Sources, Vol. 176, Issue 1, January 2008, 90-95.
Q.-A. Huang, J. Oberste-Berghaus, D. Yang, S. Yick, Z. Wang, B. Wang and R. Hui, Polarization Analysis for Metal-Supported SOFCs from Different Fabrication Processes Journal of Power Sources, 177 (2008) 339-347.
P. Fauchais, R. Etchart-Salas, C. Delbos, M. Tognonvi, V. Rat, J. F. Coudert and T. Chartier, Suspension and solution plasma spraying of finely structured layers: potential application to SOFCs, J. Phys. D: Appl. Phys. 40 (2007) 2394-2406.
J. Will, A. Mitterdorfer, C. Kleinlogel, D. Rerednis, L. J. Gauckler, Fabrication of thin electrolytes for second-generation solid oxide fuel cells, Solid State Ionics 131 (2000) 79-96.
S. Sodeoka, M. Suzuki, K. Ueno, H. Sakamoto, R. Shibata, and M. Ando, Thermal and mechanical properties of ZrO₂—CeO₂ plasma-sprayed coatings, Journal of Thermal Spray Technology, Vol. 6 (3) 1997, 361-367.
R. Henne, Solid oxide fuel cells: A challenge for plasma deposition processes, Journal of Thermal Spray Technology, Vol. 16 (3) 2007 381-403.
D. Stöver, D. Hathiramani, R. Vaβen, R. J. Damani, Plasma-sprayed components for SOFC applications, Surface and Coatings Technology 201 (2006) 2002-2005.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A coating process comprising:
a. providing ceria-based powder having a mean particle diameter smaller than about 200 nm;
b. uniformly dispersing the ceria-based powder in a combustible organic solvent to form a suspension feedstock having a solids weight ratio less than about 20%;
c. injecting the feedstock into a plume having a maximum temperature from about 2,600° C. to 4,000° C. to vaporize and consume the combustible organic solvent and heat and accelerate a spray jet of the precipitated solids for deposition on a substrate at a standoff distance where the spray jet would otherwise attain a mean velocity of about 600 m/s to 1,000 m/s, and a mean temperature of about 2,600° C. to about 3,800° C. to provide a uniform, dense, crack-free coating.

2. The coating process of claim 1 further comprising placing a substrate to be coated at a standoff distance where the spray jet would otherwise attain a mean temperature of about 2,750° C. to about 3,300° C.

3. The coating process of claim 1 wherein the spray jet is applied onto a substrate to form a coating less than: 100 μm thick, 80 μm thick, or 35 μm thick.

4. The coating process of claim 1 wherein the ceria-based powder:
consists essentially of cerium oxide;
consists essentially of cerium oxide doped or admixed with an oxide of one or more of: Nb, Ta, Gd, Sm, Y, Ca, and Sr;
consists essentially of cerium oxide doped or admixed with an oxide of gadolinium or samarium; or
consists essentially of cerium oxide doped or admixed with about 10 to 25 wt. % of samarium oxide.

5. The coating process of claim 1 wherein the ceria-based powder:
has a mean particle size less than 100 nm; or
has a mean particle size of about 20 nm.

6. The coating process of claim 1 wherein uniformly dispersing comprises:
chemically dispersing the powder by selection of the organic solvent;
chemically dispersing the powder by addition of a dispersant;
mechanically agitating the suspension;
sonication; or
2, 3 or all of the above.

7. The coating process of claim 6 wherein uniformly dispersing comprises dispersing the powder in: one or more of: ethylene glycol and ethanol; or a 3:1 mixture of ethylene glycol to ethanol.

8. The coating process of claim 1 wherein uniformly dispersing comprises producing a feedstock suspension having less than 5 wt. % of solids content.

9. The coating process of claim 1 further comprising maintaining the substrate at a temperature below 700° C. using at least one of frontside and backside cooling.

10. The coating process of claim 1 wherein the substrate is an electrode for a solid oxide fuel cell, for which the coating provides an electrolyte.

11. A coating process comprising:
a. providing ceria-based powder consisting essentially of cerium oxide doped or admixed with one of Nb, Ta, Gd, Sm, Y, Ca, and Sr, having a mean particle diameter smaller than about 100 nm;
b. uniformly dispersing the ceria-based powder in a solvent consisting essentially of one or more of: ethylene glycol and ethanol, to form a suspension feedstock having a solids weight ratio less than about 20%; and
c. injecting the feedstock into a combustion flame of a high velocity oxy-fuel gun having a maximum temperature that is from about 2,600° C. to 4,000° C. to vaporize and consume the combustible organic solvent, and impart thermal and kinetic energy to a spray jet of the precipitated solids so that the spray jet attains a mean velocity of 600 to 1000 m/s and a temperature from 2,600 to 3,800° C.; and
d. depositing the spray jet on a substrate at a standoff distance of 11.5 to 16 cm to produce a substantially uniform, dense, crack-free coating no thicker than 50 μm.

12. The coating process of claim 1 further comprising placing a substrate to be coated at a standoff distance where the spray jet would otherwise attain a mean velocity of about 2,880° C. to about 3,080° C.
